(19) United States
(12) Patent Application Publication
(10) Pub. No.: US 2022/0213394 A1
(43) Pub. Date: Jul. 7, 2022

(54) PROCESSES FOR CATALYZED RING-OPENING OF CYCLOPARAFFINS

(71) Applicant: Chevron U.S.A. Inc., San Ramon, CA (US)

(72) Inventors: Michael Girgis, Richmond, CA (US); Stacey Ian Zones, San Francisco, CA (US)

(21) Appl. No.: 17/528,516

(22) Filed: Nov. 17, 2021

Related U.S. Application Data
(60) Provisional application No. 63/134,862, filed on Jan. 7, 2021.

(51) Int. Cl. C10G 47/18; B01J 29/74

(52) U.S. Cl. CPC C10G 47/18; B01J 29/7469; C10G 2300/1096; C10G 2300/70; C10G 2300/4012; C10G 2300/4018; C10G 2300/4006

(57) ABSTRACT

Embodiments of the disclosure include processes for selective ring-opening of cycloparaffins in hydrocarbon feeds to produce hydrocracked cycloparaffins. In particular, the process comprises contacting a hydrocarbon feed comprising cycloparaffins with hydrogen and a catalyst comprising an unsulfided, low-acidity, metal-containing zeolite under hydrocracking conditions; wherein the metal is selected from the group consisting of platinum, nickel, rhodium and mixtures thereof. The processes are useful for upgrading petroleum streams to lubricant base stocks.

### RELATED APPLICATIONS

The present application claims priority to U.S. Provisional Patent Application No. 63/134,862 filed Jan. 7, 2021, the entire contents of which is incorporated herein by reference.

### TECHNICAL FIELD

The present disclosure relates to processes for selective ring-opening of cycloparaffins in hydrocarbon feeds with unsulfided, low-acidity, metal-containing zeolites catalysts.

### BACKGROUND

Hydroprocessing includes processes which convert hydrocarbons in the presence of hydroprocessing catalysts and hydrogen to more valuable products. Hydrocracking is a type of hydroprocessing in which bonds in hydrocarbon compounds are broken in the presence of hydrogen and a hydrocracking catalyst.

Naphthenes, or cycloparaffins, are a class of cyclic aliphatic hydrocarbons obtained from petroleum. These compounds have the general formula CₙH₂ₙ and are characterized by having one or more rings of saturated carbon atoms. In cycloparaffins with multiple rings, the rings can be fused. Naphthenes are an important component of liquid petroleum refinery products. Most of the heavier boiling point complex residues are cycloalkanes. Naphthenic crude oil is more readily converted into gasoline than paraffin-rich crudes are.

In hydrocracking processes, it is desirable to open the rings of cycloparaffins to produce n-paraffins and branched paraffins. In particular, cycloparaffin-ring opening is an important reaction for upgrading petroleum streams to lubricant base stocks, as branched paraffins have a higher viscosity index (VI) than cycloparaffins. Branched paraffins typically possess superior cold flow properties compared to cycloparaffins.

In view of the foregoing, there is an ongoing need to provide cycloparaffin ring-opening catalysts and processes for improving hydroconversion of cycloparaffins in hydrocarbon feeds.

### SUMMARY

This summary is provided to introduce various concepts in a simplified form that are further described below in the detailed description. This summary is not intended to identify required or essential features of the claimed subject matter nor is the summary intended to limit the scope of the claimed subject matter.

Aspects of this disclosure are directed to processes for selective ring-opening of cycloparaffins in hydrocarbon feeds to produce hydrocracked cycloparaffins. Advantageously, the processes can be used to selectively produce ring-opening of cycloparaffins with minimal formation of light by-products.

In one aspect, a process for selective ring-opening of cycloparaffins in a hydrocarbon feed comprises: contacting a hydrocarbon feed comprising cycloparaffins with hydrogen and a catalyst comprising an unsulfided, low-acidity, metal-containing zeolite under hydrocracking conditions to produce hydrocracked cycloparaffins; wherein the metal is selected from the group consisting of platinum, nickel, rhodium and mixtures thereof.

In one aspect, a process for selective ring-opening of cycloparaffins in a hydrocarbon feed comprises: contacting a hydrocarbon feed comprising cycloparaffins with hydrogen and a catalyst comprising an unsulfided, low-acidity, platinum-containing zeolite under hydrocracking conditions to produce hydrocracked cycloparaffins.

In another aspect, an unsulfided, low-acidity, metal-containing zeolite and hydrogen are used for selectively producing hydrocracked cycloparaffins in accordance with a process described herein; wherein the metal is selected from the group consisting of platinum, nickel, rhodium and mixtures thereof.

In another aspect, an unsulfided, low-acidity, platinum-containing zeolite and hydrogen are used for selectively producing hydrocracked cycloparaffins in accordance with a process described herein.

In another aspect, a hydrocracked cycloparaffin composition is produced in accordance with a process described herein.

This summary and the following detailed description provide examples and are explanatory only of the disclosure. Accordingly, the foregoing summary and the following detailed description should not be considered to be restrictive. Additional features or variations thereof can be provided in addition to those set forth herein, such as for example, various feature combinations and sub-combinations of those described in the detailed description.

### BRIEF DESCRIPTION OF THE DRAWINGS

FIG. 1 is a diagram illustrating the loading of catalyst in a catalyst bed for an exemplary process.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While compositions and methods are described in terms of “comprising” various components or steps, the compositions and methods can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

“Periodic Table” refers to the version of IUPAC Periodic Table of the Elements dated Jun. 22, 2007, and the numbering scheme for the Periodic Table Groups is as described in Chemical and Engineering News, 63(5), 27 (1985).

“Hydrocarbonaceous” and “hydrocarbon” refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

“Hydroprocessing” or “hydroconversion” refers to a process in which a carbonaceous feedstock is brought into contact with hydrogen and a catalyst, at a higher temperature and pressure, for the purpose of removing undesirable impurities and/or converting the feedstock to a desired product. Such processes include, but are not limited to, methanation, water gas shift reactions, hydrogenation, hydrotreating, hydrodesulphurization, hydrodenitrogenation, hydrodemetallation, hydrodearomatization, hydroisomerization, hydrodewaxing and hydrocracking including selective hydrocracking. Depending on the type of hydroprocessing and the reaction conditions, the products of hydroprocessing can show improved physical properties such as improved viscosities, viscosity indices, saturates content, low temperature properties, volatilities and depolarization.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins into non-cyclic paraffins.

“Cycloparaffin” refers to a compound having the general formula CₙH₂ₙ and are characterized by having one or more rings of saturated carbon atoms. In cycloparaffins with multiple rings, the rings can be fused. Cycloparaffins can include substituents and aromatic rings, but must also contain one or more rings of saturated carbon atoms.

The terms “binder” or “support”, particularly as used in the term “catalyst support”, refer to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a crystalline microporous solid having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

The terms “catalyst particles”, “catalyst composition,” “catalyst mixture,” “catalyst system,” and the like, encompass the initial starting components of the composition, as well as whatever product(s) may result from contacting these initial starting components, and this is inclusive of both heterogeneous and homogenous catalyst systems or compositions.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Although any processes and materials similar or equivalent to those described herein can be used in the practice or testing of the invention, the typical processes and materials are herein described.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

### DETAILED DESCRIPTION

It is to be understood that the disclosure is not limited in its application to the details of construction and the arrangement of components set forth in the following description or illustrated in the drawings.

The present disclosure generally relates to processes for cycloparaffinic ring-opening by contacting a cycloparaffin with hydrogen in the presence of a hydrocracking catalyst that is selective for producing hydrocracked cycloparaffin compounds. In general, the hydrocracking catalyst comprises an unsulfided, low-acidity, metal-containing zeolite (e.g., a platinum-containing zeolite), which facilitates ring-opening (i.e., carbon-carbon bond breaking) at unsubstituted carbon atoms in the cycloparaffin compound; wherein the metal is selected from the group consisting of platinum, nickel, rhodium and mixtures thereof.

In certain embodiments, the processes disclosed herein may be used for reacting hydrocarbon feed at conditions of elevated temperatures and pressures in the presence of hydrogen and hydrocracking catalyst particles to convert the cycloparaffins in the feed to hydrocracked cycloparaffin compounds, including n-paraffins and branched paraffins.

Cycloparaffin ring-opening is an important reaction for upgrading petroleum streams. Superior cold flow properties (i.e., low pour point) can be achieved by converting cycloparaffins to branched paraffins. Aromatic ring saturation may also occur during the processes described herein. In certain embodiments, the process can be used to upgrade components containing aromatic rings to branched paraffins, thereby improving viscosity index cold flow properties.

In one embodiment, a process for selective ring-opening of cycloparaffins in a hydrocarbon feed comprises: contacting a hydrocarbon feed comprising cycloparaffins with hydrogen and a catalyst comprising an unsulfided, low-acidity, metal-containing zeolite under hydrocracking conditions to produce hydrocracked cycloparaffins; wherein the metal is selected from the group consisting of platinum, nickel, rhodium and mixtures thereof. In certain embodiments, the metal is platinum.

The process may be used to produce hydrocracked cycloparaffin compositions from cycloparaffins. Generally, the cycloparaffin ring-opening reaction catalyzed by the unsulfided, low-acidity, metal-containing zeolite occurs between unsubstituted carbons in a cycloalkyl portion of the cycloparaffin compound. For example, the reaction carried out on decalin or tetralin would produce the hydrocracked cycloparaffin products shown below.

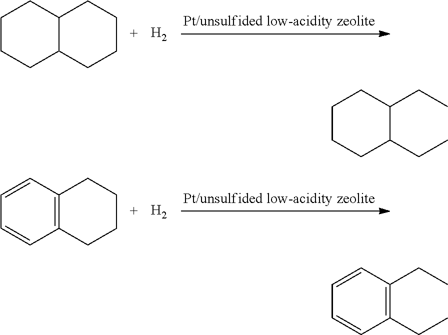

The cycloparaffin ring-opening reaction catalyzed by the exemplary catalysts often results in more highly-branched products than those obtained using sulfide low-acidity metal-containing zeolites (see, e.g., (1) Martens, J. A., and Jacobs, P. A., “Conceptual Background for the Conversion of Hydrocarbons on Heterogeneous Catalysts”, in Theoretical Aspects of Heterogeneous Catalysis, J. B. Moffatt, E d., Van Nostrand Reinhold, N.Y., 1990; and (2) Girgis, M. J., and Tsao, Y. P., Ind. End. Chem. Res., 1996, 35, pp. 386-396.)

In certain embodiments, the cycloparaffins comprise C₆₊, C₇₊, C₈₊, C₉₊, or C₁₀₊ cycloparaffins. The C₆₊, C₇₊, C₈₊, C₉₊, or C₁₀₊ content can be greater than about 50 wt %, about 60 wt %, about 70 wt %, about 80 wt %, about 90 wt %, about 95 wt %, about 98 wt %, or about 100 wt % in the hydrocarbon feed. Suitable feeds comprising cycloparaffins include, for example, petroleum streams, hydrocracker recycle streams, gas oils, paraffinic resids, and reaction products from aromatics hydrogenation processes. An example of reaction products from aromatics hydrogenation processes is the effluent from a hydrotreater in which the aromatics-rich feed is contacted with hydrogen in the presence of a metal sulfide catalyst to produce cycloparaffins.

In certain embodiments, the cycloparaffins comprise C₁₀₊ cycloparaffins (i.e., cycloparaffins including at least 10 carbons). In certain embodiments, the cycloparaffins comprise C₆₊ cycloparaffins (i.e., cycloparaffins including at least 6 carbons). In certain embodiments, the cycloparaffins comprise C₅ to C₁₀₀, C₅ to C₆₀, C₅ to C₁₈, C₆ to C₁₄, C₆ to C₁₂ or C₆₀ to C₁₀₀ cycloparaffins.

In some embodiments, the cycloparaffins comprise 2- or 3-ring hydrocarbon compounds (e.g. naphthenes), such as decalin (cis- or trans-decalin, and mixtures thereof). In certain embodiments, the cycloparaffins include one or more aromatic rings.

Generally, the catalysts (or catalyst compositions) useful in the cycloparaffin ring-opening processes is a low-acidity, metal-containing zeolite that has not been sulfided (i.e., unsulfided); wherein the metal is selected from the group consisting of platinum, nickel, rhodium and mixtures thereof. The selectivity of the sulfided versions of the catalysts can be different from the unsulfided versions. In certain embodiments, the catalyst or catalyst composition comprises a low-acidity, platinum-containing zeolite that has not been sulfided.

The metal may be incorporated into the catalyst composition by any suitable method known in the art, such as impregnation or exchange onto the zeolite. The metal may be incorporated in the form of a cationic, anionic or neutral complex. For example, [Pt(NH₃)₄]²⁺ and cationic complexes of this type will be found convenient for exchanging platinum onto the zeolite. In certain embodiments, the amount of metal on the zeolite is about 0.003 to about 10 percent by weight, about 0.01 to about 10 percent by weight, about 0.1 to about 2.0 percent by weight, or about 0.1 to about 1.0 percent by weight. In certain embodiments, the amount of platinum on the zeolite is about 0.01 to about 10 percent by weight, about 0.1 to about 2.0 percent by weight, or about 0.1 to about 1.0 percent by weight. In certain embodiments, the source of platinum in the catalyst synthesis is platinum tetraamine dinitrate. In certain embodiments, the metal is introduced into the catalyst composition with a pH neutral or basic solution. In certain embodiments, the platinum is introduced into the catalyst composition with a pH neutral or basic solution.

A high level of metal dispersion in the catalyst or catalyst composition is generally preferred. For example, platinum dispersion is measured by the hydrogen chemisorption technique and is expressed in terms of H/Pt ratio. The higher the H/Pt ratio, the higher the platinum dispersion. In certain embodiments, the zeolite should have an H/Pt ratio greater than about 0.8.

One or more binder materials may also be used with the zeolite. Generally desirable properties for the binder material are good mixing/extrusion characteristics, good mechanical strength after calcination, and reasonable surface area and porosity to avoid possible diffusion problems during catalyst use. Examples of suitable binder materials include, but are not limited to: silica-containing binder materials, such as silica, silica alumina, silica-boria, silica-magnesia, silica-zirconia, silica-thoria, silica-berylia, silica-titania, silica-alumina-boria, silica alumina-thoria, silica-alumina-zirconia, silica-alumina magnesia or silica-magnesia-zirconia; inorganic oxides; aluminum phosphate; and combinations thereof. In certain embodiments, the binder material does not comprise zeolitic materials.

When used, the ratio of binder to zeolite will typically vary from about 9:1 to about 1:9, more commonly from about 3:1 to about 1:3 (by weight).

Generally, the zeolite useful in the catalyst compositions and processes described herein is an aluminosilicate with low-acidity, including low alumina content and/or a high silica-to-alumina mole ratio. In one embodiment, the zeolite is an aluminosilicate. In certain embodiments, the zeolite is an aluminosilicate having a low alumina content and/or a high silica-to-alumina mole ratio.

While not specifically limited to a particular lower value or range, the zeolite silica-to-alumina mole ratio is of a sufficient value or range to selectively produce hydrocracked cycloparaffin products. Generally, the low-acidity zeolites having silica-to-alumina mole ratios (SARs) of at least 100. In certain embodiments, the low-acidity zeolites having SARs of at least 100, 110, or 120. In certain embodiments, the low-acidity zeolites having SARs in the range of about 100 to about 120. In certain embodiments, the zeolite has an SAR of a sufficient value or range to selectively produce ring-opening of cycloparaffins with minimal formation of light by-products. In certain embodiments, the zeolite has an SAR of at least 100.

In certain embodiments, the zeolite is an aluminosilicate that does not contain boron. In certain embodiments, the zeolite is not a borosilicate. In certain embodiments, the zeolite is not an aluminoborosilicate.

Specific examples of suitable zeolites may include, but are not limited to: SSZ-32, SSZ-35, SSZ-54, SSZ-70, SSZ-74, SSZ-91, SSZ-95, SSZ-109, SSZ-31, SSZ-42, SSZ-43, SSZ-48, SSZ-55, SSZ-57, SSZ-63, SSZ-64, SSZ-65, SSZ-96, SSZ-106, SSZ-111, SSZ-118, SSZ-122, Y, USY, Beta, ZSM-4, MFI (e.g., ZSM-5), ZSM-12, ZSM-18, ZSM-20, MTT (e.g., ZSM-23), FER (e.g., ZSM-35), *MRE (e.g., ZSM-48), L and combinations thereof. Zeolites noted herein are well-described in the art, see e.g., U.S. Pat. Nos. 5,284,985 and 5,364,997. In certain embodiments, the zeolite is selected from medium-pore zeolites, such as SSZ-32, SSZ-35, SSZ-54, SSZ-70, SSZ-74, SSZ-91, SSZ-95, SSZ-109 and the like. In certain embodiments, the zeolite is selected from large-pore zeolites, such as SSZ-31, SSZ-42, SSZ-43, SSZ-48, SSZ-55, SSZ-57, SSZ-63, SSZ-64, SSZ-65, SSZ-96, SSZ-106, SSZ-111, SSZ-118, SSZ-122 and the like. In certain embodiments, the zeolite is selected from Y, USY, Beta, ZSM-4, ZSM-12, ZSM-18, ZSM-20, L and combinations thereof. In certain embodiments, the zeolite is an aluminosilicate zeolite comprising ZSM-12.

Typically, the process is conducted under suitable hydrocracking conditions for the particular catalyst used. In certain embodiments, the process is conducted at a temperature of about 200° C. to about 400° C., about 270° C. to about 330° C., or about 270° C. to about 300° C. In certain embodiments, the process is conducted at a pressure in the range of about 1 psig to about 2000 psig or about 200 psig to about 2000 psig. In certain embodiments, the process is conducted at a weight hourly space velocity in the range of about 0.4 to about 2.0 WHSV hr⁻¹ or about 0.4 to about 0.7 WHSV hr⁻¹. In one embodiment, the process (or hydrocracking) conditions comprise a temperature of about 200° C. to about 400° C. and a pressure in the range of about 200 psig to about 2000 psig. In one embodiment, the process (or hydrocracking) conditions comprise a temperature of about 200° C. to about 400° C., a pressure in the range of about 200 psig to about 2000 psig, and a weight hourly space velocity in the range of about 0.4 to about 0.7 WHSV hr⁻¹.

The amount of hydrogen present in the process can be in the range of about 2 to about 10 for the H₂/cycloparaffin mole ratio. Typically, the amount of hydrogen present in the process is in the range of about 3 to about 5 for the H₂/cycloparaffin mole ratio.

In some embodiments, the process is conducted with a low sulfur feed having less than about 500 ppm sulfur, or less than about 50 ppm sulfur. Feeds having less than about 500 ppm sulfur without preliminary hydrotreatment prior to contacting with the unsulfided catalyst composition of the present invention are preferred. In some embodiments, the process is conducted with less than about 50 ppm nitrogen.

In one embodiment, a hydrotreating step using a conventional hydrotreating catalyst may also be carried out to remove nitrogen and sulfur and to saturate aromatics to naphthenes without substantial boiling range conversion. Suitable hydrotreating catalysts generally comprise a metal hydrogenation component, usually a Group 6 or Group 8-10 metal. Hydrotreating will usually improve catalyst performance and permit lower temperatures, higher space velocities, lower pressures or combinations of these conditions to be employed.

The process of the present disclosure provides a number of advantages, as supported by the examples that follow, including facilitating ring-opening of cycloparaffins between unsubstituted carbons with high conversion rates and high selectivity. In certain embodiments, the process results in greater than about 90% conversion of the cycloparaffins in the hydrocarbon feed. In certain embodiments, the process results in selectivity for ring-opening products of greater than about 60% or about 65% of the cycloparaffins in the hydrocarbon feed. Advantageously, processes according to the embodiments can be used to facilitate cycloparaffin ring-opening without excessive formation of less-valuable light products (e.g., gases such as methane, ethane and propane).

In one aspect, the present disclosure provides for an unsulfided, low-acidity, metal-containing zeolite and hydrogen for selectively producing hydrocracked cycloparaffins in a process according to the embodiments described herein.

In one aspect, the present disclosure provides a hydrocracked cycloparaffin composition produced in a process according to the embodiments described herein.

### EXAMPLES

The disclosed embodiments are further illustrated by the following examples, which are not to be construed in any way as imposing limitations to the scope of this disclosure. Various other aspects, embodiments, modifications, and equivalents thereof may be apparent to one of ordinary skill in the art, after reading the description herein, without departing from the scope of the present disclosure or the scope of the amended claims.

### Example 1. Exemplary Catalyst and Cycloparaffin Ring-Opening Process

A. Preparation of Pt/ZSM-12 Catalyst

A 2-gram sample of ZEO217, a ZSM-12 structure available from Zeolyst, was calcined to remove the organic template, and then loaded into a vial with 12 grams of water and 20 grams of 0.148 M NH₄OH solution. Platinum tetraamine dinitrate solution (2 grams) was added to the vial. The platinum tetraamine dinitrate solution is prepared from dissolving 0.286 grams of platinum tetraamine dinitrate (Aesar; 49 wt % Pt), in 24.5 grams of water and 4.1 grams of a 0.148 M NH₄OH solution to provide buffering. 1 gram of this solution will provide a catalyst with 0.5 wt % loading if all the Pt ends up on the zeolite.

The contents are let to sit at room temperature for 2 days. Then the solids are collected by filtration and washed with 50 cc of water in 3 portions. Upon drying in vacuo, the solids are then transferred to an oven at 90° C. and dried for 2 hours. Then the solids are spread thinly on a Pyrex dish and calcined according to the following program: in positive flow of air at 1° C./minute, raise the temperature to 120° C.; then hold for 2 hours at this temperature; and then again at the same rate, raise the temperature to 300° C. and hold for 3 hours. The final product comprises 0.701 wt % Al, 44.8 wt % Si and 0.447 wt % Pt.

### B. Process Example

The catalyst is pelleted and sieved to 20-40 mesh granules.

0.70 g of Pt/ZSM-12 is charged to a fixed-bed reactor, such as a down-flow trickle bed reactor.

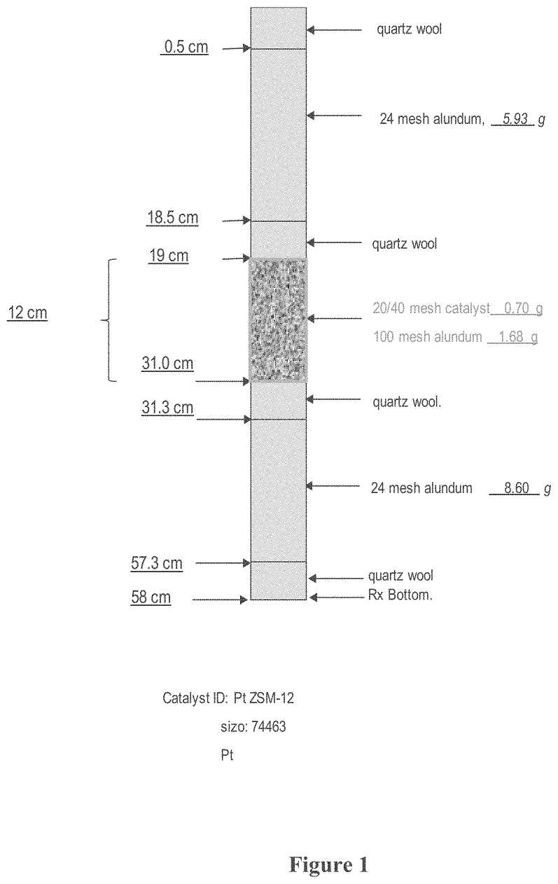

The catalyst loading diagram is shown in FIG. 1. The catalyst bed is situated in the isothermal zone of a furnace.

Catalyst properties are given in Table 1. The low Al content of the catalyst results in a low concentration of acid sites and a high silica to alumina mole (SAR) ratio (i.e., >100).

TABLE 1

| Catalyst ID | Pt ZSM-12 |
|---|---|
| Pt dispersion total % | 70.00 |
| Pt dispersion strong % | 29.50 |
| Pt wt % | 0.45 |
| Al wt % | 0.70 |
| Si wt % | 41.8 |
| SiO₂/Al₂O₃ Mol ratio (SAR) | 115 |

The catalyst is dried by N2 flowing at 50 cc/min at 250° F. and 1 atm for 4 h. The catalyst is reduced by H₂ flowing at 50 cc/min at 600° F. and 1 atm for 2 h.

Reaction is started by introducing a hydrocarbon feed (comprised of n-hexadecane) and hydrogen to the fixed-bed.

An experiment is performed by contacting a feed comprised of 60% trans-decalin and 40% cis-decalin, with about 3 wt % n-hexadecane with the catalyst in the fixed-bed.

The feed is analyzed using two-dimensional GC and the feed analysis is shown in Table 2. The feed is then contacted with the catalyst at 1200 psig, 545° F., and WHSV=0.57, H₂/decalins mole ratio of 4.2. After a 46-h lineout period, a 24-h yield period is performed. The liquid reaction product collected at the end of the yield period is analyzed by two-dimensional GC. The product analysis is also shown in Table 2.

TABLE 2

| Product class | Feed Weight % | Product Weight % |
|---|---|---|
| Paraffin C₈ | 0 | 2 |
| Paraffin C₉ | 0 | 1 |
| Paraffin C₁₀ | 0 | 8 |
| C₈ Mononaphthenes | 0 | 3 |
| C₉ Mononaphthenes | 0 | 2 |
| C₁₀ Mononaphthenes | 0 | 62 |
| C₁₀ Dinaphthenes | 0 | 16 |
| Trans-Decalin | 60 | 7 |
| Cis-Decalin | 40 | 1 |

The presence of 62 wt % C₁₀-mononaphthenes in the product analysis supports that significant ring-opening of the decalin compound in the feed. Decalin compounds are 2-ring naphthenes.

The small amount being (3 wt % in total) of light products (C₈- and C₉-) present in the product analysis supports the conclusion that the ring-opening is selective with minimal formation of light by-products.

Conversion, yield of major products, and selectivity yield to C₁₀ mononaphthene ring-opening products are as given in Table 3.66% selectivity to mononaphthene ring-opening products is achieved at 93% conversion using Pt/low-acidity ZSM-12.

TABLE 3

| | |
|---|---|
| Conversion of Decalins | 93% |
| Mol % yield of Dinaphthenes | 16% |
| Mol % yield of Mononaphthenes | 61% |
| Selectivity to ring-opening products | 66% |

While the disclosure includes a limited number of embodiments, those skilled in the art, having the benefit of this disclosure, will appreciate that other embodiments may be devised which do not depart from the scope of the present disclosure.

What is claimed is:

1. A process for selective ring-opening of cycloparaffins comprising: contacting a hydrocarbon feed comprising cycloparaffins with hydrogen and a catalyst comprising an unsulfided, low-acidity, metal-containing zeolite under hydrocracking conditions to produce hydrocracked cycloparaffins; wherein the metal is selected from the group consisting of platinum, nickel, rhodium and mixtures thereof.

2. The process of claim 1, wherein the zeolite is an aluminosilicate.

3. The process of claim 2, wherein the zeolite silica-to-alumina mole ratio is of a sufficient value or range to selectively produce ring-opening of cycloparaffins with minimal formation of light by-products.

4. The process of claim 2, wherein the zeolite silica-to-alumina mole ratio is at least about 100.

5. The process of claim 1, wherein the zeolite is an aluminosilicate zeolite hydrocracking catalyst selected from SSZ-32, SSZ-35, SSZ-54, SSZ-70, SSZ-74, SSZ-91, SSZ-95, SSZ-109, SSZ-31, SSZ-42, SSZ-43, SSZ-48, SSZ-55, SSZ-57, SSZ-63, SSZ-64, SSZ-65, SSZ-96, SSZ-106, SSZ-111, SSZ-118, SSZ-122, Y, USY, Beta, ZSM-4, MFI (e.g., ZSM-5), ZSM-12, ZSM-18, ZSM-20, MTT (e.g., ZSM-23), FER (e.g., ZSM-35), *MRE (e.g., ZSM-48), L and combinations thereof. The process of claim 1, wherein the zeolite is an aluminosilicate zeolite hydrocracking catalyst selected from SSZ-32, SSZ-35, SSZ-54, SSZ-70, SSZ-74, SSZ-91, SSZ-95, and SSZ-109.

6. The process of claim 1, wherein the zeolite is an aluminosilicate zeolite hydrocracking catalyst selected from SSZ-31, SSZ-42, SSZ-43, SSZ-48, SSZ-55, SSZ-57, SSZ-63, SSZ-64, SSZ-65, SSZ-96, SSZ-106, SSZ-111, SSZ-118, and SSZ-122.

7. The process of claim 1, wherein the zeolite is an aluminosilicate zeolite hydrocracking catalyst selected from Y, USY, Beta, ZSM-4, MFI (e.g., ZSM-5), ZSM-12, ZSM-18, ZSM-20, MTT (e.g., ZSM-23), FER (e.g., ZSM-35), *MRE (e.g., ZSM-48), and L.

8. The process of claim 1, wherein the hydrocarbon feed comprises C₁₀₊ cycloparaffins.

9. The process of claim 8, wherein the C₁₀₊ cycloparaffin content is greater than about 50 wt % hydrocarbon feed.

10. The process of claim 1, wherein the hydrocracking conditions comprise a temperature of about 200° C. to about 400° C., a pressure in the range of about 200 psig to about 2000 psig, and weight hourly space velocity in the range of about 0.4 to about 0.7 WHSV hr⁻¹.

11. The process of claim 1, wherein the unsulfided, low-acidity, metal-containing zeolite is an unsulfided, low-acidity, platinum-containing zeolite.

12. Use of an unsulfided, low-acidity, metal-containing zeolite and hydrogen for selectively producing hydrocracked cycloparaffins in accordance with the process of claim 1.

13. The use of claim 12, wherein the unsulfided, low-acidity, metal-containing zeolite is an unsulfided, low-acidity, platinum-containing zeolite.

14. The use of claim 12, wherein the zeolite is an aluminosilicate.

15. A hydrocracked cycloparaffin composition produced in accordance with the process of claim 1.

16. The hydrocracked cycloparaffin composition of claim 15, wherein the unsulfided, low-acidity, metal-containing zeolite is an unsulfided, low-acidity, platinum-containing zeolite.

17. The hydrocracked cycloparaffin composition of claim 15, wherein the zeolite is an aluminosilicate.
